(19) United States
(12) Patent Application Publication
(10) Pub. No.: US 2025/0390129 A1
(43) Pub. Date: Dec. 25, 2025

(54) ADAPTIVE VOLTAGE SUPPLY CONTROLLER

(71) Applicant: NRLAB Co., Ltd., Gyeonggi-do (KR)

(72) Inventors: Yoo Hwan KIM, Gyeonggi-do (KR); Hyun Hwan YOO, Gyeonggi-do (KR); Jong Mo LIM, Gyeonggi-do (KR)

(21) Appl. No.: 19/238,921

(22) Filed: Jun. 16, 2025

(30) Foreign Application Priority Data
Jun. 21, 2024 (KR) 10-2024-0080866
May 22, 2025 (KR) 10-2025-0066885

(51) Int. Cl. G05F 1/569

(52) U.S. Cl. CPC G05F 1/569

(57) ABSTRACT

Disclosed is an adaptive voltage supply controller including: a voltage level detection unit configured to detect whether an applied voltage corresponds to a first voltage or a second voltage, both being supplied from an external source; a supply voltage generation unit configured to generate, from the first voltage, a supply voltage for operating a switch that performs a switching operation between a transmission mode and a reception mode for a high-frequency radio signal; a bypass circuit unit configured to bypass the second voltage to the switch; and a voltage supply control unit configured to, based on the detection result of the voltage level detection unit, control the supply voltage generation unit to operate when the first voltage is detected, and control the second voltage to be provided as a supply voltage for operation of the switch via the bypass circuit unit when the second voltage is detected.

### CROSS-REFERENCE TO RELATED APPLICATIONS

This application claims priority from Korean Patent Application Nos. 10-2024-0080866 filed on Jun. 21, 2024 and 10-2025-0066885 filed on May 22, 2025 in the Korean Intellectual Property Office, the contents of which in its entirety are herein incorporated by reference.

### FIELD

The present invention relates to an adaptive voltage supply controller capable of satisfying a certain level or higher of switch performance for a high-frequency radio signal regardless of the level of an applied voltage (V_{IO}) supplied from an external source.

### BACKGROUND

In a high-frequency switch device, when a controller power supply of a switch and a power supply of a mobile industry processor interface radio frequency front-end (MIPI RFFE) circuit are used together, in the conventional technology, a voltage of 1.8 [V] is generally applied to the power supply of the MIPI RFFE. In such a case, since the power supply of the analog circuit of the switch also uses the same MIPI RFFE power supply, it operates at 1.8 [V].

To control the gate body of the switch, both a positive voltage and a negative voltage are required. The magnitudes of these voltages can be adjusted according to the gate bias conditions of the switch within a range that does not exceed the breakdown voltage of the device being used.

However, in general cases, to achieve optimal performance of the switch, a positive voltage of 1.8 [V] or higher and a negative voltage of −1.8 [V] or lower are required.

FIGS. 1 and 2 are construction block diagrams illustrating conventional high-frequency switching devices.

As shown in FIG. 1, the applied voltage (V_{IO}) is lowered to a specific voltage through a low dropout regulator (LDO) circuit. Then, in a negative generator and positive generator circuits, the LDO voltage is doubled to apply the gate/body bias for the switch. Also, in the case of FIG. 2, when the gate/body bias of the switch does not require a voltage greater than 1.8 [V]/−1.8 [V], the LDO is not used and the bias of the switch is used directly.

Both of the above cases assumes that a constant power supply of 1.8 [V] is applied.

However, currently, the applied voltage (V_{IO}) must satisfy the performance requirements in both cases of 1.8 [V] and 1.2 [V]. In such a case, if a power supply of 1.8 [V] is applied, the performance of the switch can be satisfied, but if 1.2 [V] is applied, using 1.2 [V]/−1.2 [V] for the switch bias without an LDO cannot satisfy the switch performance.

Thus, it becomes necessary to use an LDO to double the output of LDO.

However, if the same configuration is used for 1.8 [V] and 1.2 [V], it is difficult for the LDO output to exceed 1.1 [V] at most. Therefore, in the case of 1.2 [V], the performance may degrade compared to using the switch without an LDO.

### PRIOR ART DOCUMENT

### Patent Document

Korean Patent No. 10-1823269

### SUMMARY

### Technical Problem

An objective of the present invention is to provide an adaptive voltage supply controller for supplying an optimal bias to the switch gate and body according to the applied voltage when there are two types of applied voltages (for example, 1.8 [V] and 1.2 [V]).

### Technical Solution

To achieve the above objective, there is provided an adaptive voltage supply controller including: a voltage level detection unit configured to detect whether an applied voltage corresponds to a first voltage or a second voltage, both being supplied from an external source; a supply voltage generation unit configured to generate, from the first voltage, a supply voltage for operating a switch that performs a switching operation between a transmission mode and a reception mode for a high-frequency radio signal; a bypass circuit unit configured to bypass the second voltage to the switch; and a voltage supply control unit configured to, based on the detection result of the voltage level detection unit, control the supply voltage generation unit to operate when the first voltage is detected, and control the second voltage to be provided as a supply voltage for operation of the switch via the bypass circuit unit when the second voltage is detected.

The voltage supply control unit may stop the operation of the supply voltage generation unit when the voltage level detection unit detects that the second voltage is applied.

The supply voltage generation unit may be programmed to output a supply voltage to be supplied to the switch in a variable manner under the control of the voltage supply control unit.

### Effects of the Invention

According to the present invention, in a case where two applied voltages, a first voltage and a second voltage, are supplied from an external source, the applied voltage is detected to determine whether it is the first voltage or the second voltage. When the first voltage is detected, a voltage generation unit is controlled to operate, and when the second voltage is detected, the second voltage is provided as a switching drive voltage for driving a switch through a bypass circuit unit, thereby enabling a certain level or higher of switch performance to be satisfied regardless of the level of the applied voltage supplied externally.

### BRIEF DESCRIPTION OF THE DRAWINGS

FIGS. 1 and 2 are construction block diagrams illustrating conventional high-frequency switching devices.

FIG. 3 is a construction block diagram illustrating the connection state of an adaptive voltage supply controller of the present invention in a high-frequency switching device.

FIG. 4 is a block diagram illustrating the detailed components of the adaptive voltage supply controller shown in FIG. 3.

FIG. 5 is a diagram illustrating a voltage level detection unit according to an embodiment of the present invention.

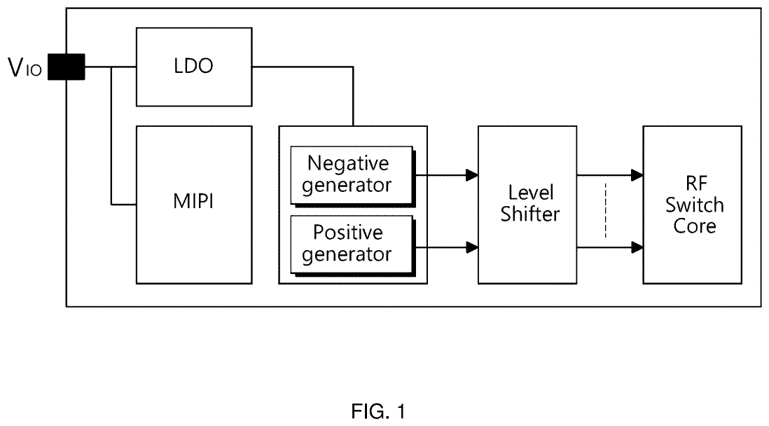

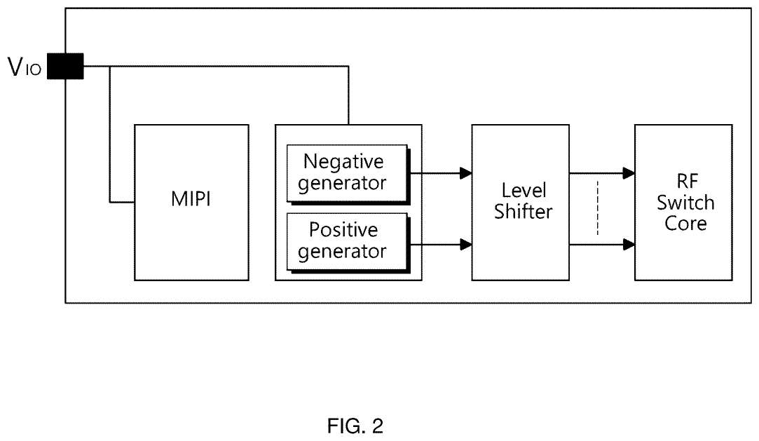

### DETAILED DESCRIPTION

Hereinafter, exemplary embodiments of the present invention will be described in detail with reference to the accompanying drawings.

The embodiments of the present invention are provided to more completely explain the present invention to one of ordinary skill in the art. The embodiments of the present invention may be modified in various forms, and the scope of the present invention is not limited to the following embodiments. Rather, these embodiments are provided to make the present disclosure more substantial and complete and to completely transfer the concept of the present invention to those skilled in the art.

The terms used herein are to explain particular embodiments and not intended to limit the present invention. As used herein, singular forms may include plural forms unless particularly defined otherwise in context. Also, as used herein, the term “and/or” includes any and all combinations or one of a plurality of associated listed items.

In general, when an applied voltage (VIO) is used as an analog power supply for generating a switch bias, if it is fixed at 1.8 [V], there is no problem in designing a switch bias generation circuit and satisfying RF performance. However, when there are two types of applied voltage, 1.2 [V] and 1.8 [V], if the bias circuit is designed fixed to either one, performance degradation occurs. To prevent such performance degradation, it is necessary to enable the generation of a voltage that can optimize RF switch performance in a switch bias generation unit, regardless of the magnitude of the applied voltage.

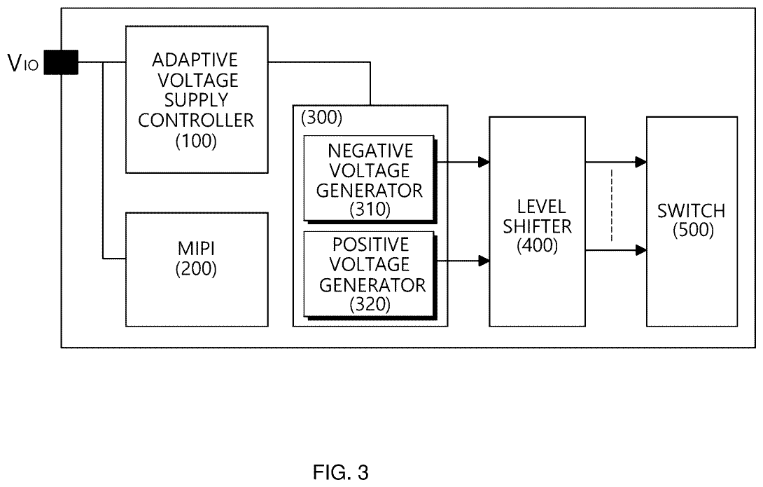

FIG. 3 is a configuration block diagram illustrating the connection state of an adaptive voltage supply controller 100 of the present invention in a high-frequency switch device.

Referring to FIG. 3, the high-frequency switch device includes the adaptive voltage supply controller 100 of the present invention, a mobile industry processor interface (MIPI) 200, a bias generation unit 300, a level shifter 400, and a switch 500.

A detailed description of the adaptive voltage supply controller 100 will be provided below.

The MIPI 200 is responsible for interfacing between an application processor (AP), a transceiver, and peripheral devices in a mobile environment, and in RF front end applications, it is designed in accordance with the RF front-end (RFFE) standard.

The bias generation unit 300 generates the bias voltage required for the operation of the switch 500. To this end, the bias generation unit 300 includes a negative voltage generator 310 and a positive voltage generator 320.

The negative voltage generator 310 lowers the supply voltage provided from the adaptive voltage supply controller 100 to a negative voltage greater than twice the magnitude, and transmits it to the level shifter 400.

The positive voltage generator 320 raises the supply voltage provided from the adaptive voltage supply controller 100 to a positive voltage greater than twice the magnitude, and transmits it to the level shifter 400.

The level shifter 400 serves to generate the bias applied to the gate and body in order to optimize the performance of the switch. For example, for a switch that is turned on, a positive voltage must be applied to the gate and 0 [V] to the body, whereas for a switch that is turned off, a negative voltage must be applied to both the gate and the body. To provide such bias to the switch circuit, the level shifter 400 is a circuit that generates an output voltage based on the voltage of the bias generation unit 300 and the output from the MIPI 200.

The switch 500 performs a switching operation between a transmission mode and a reception mode for a high-frequency radio signal. The switch 500 controls the gate/body bias for switching between transmission and reception modes for transmitting and receiving a high-frequency radio signal, according to the supply voltage provided from the level shifter 400.

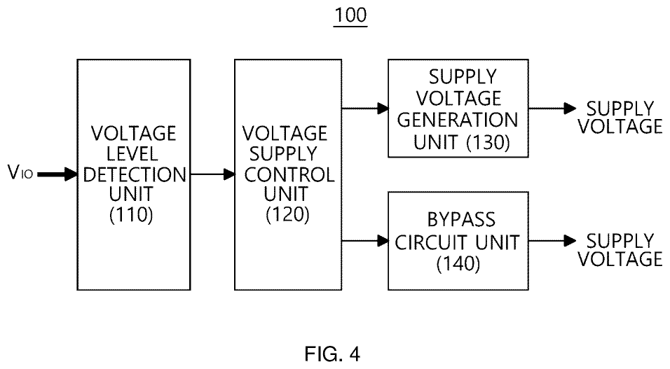

FIG. 4 is a block diagram illustrating the detailed components of the adaptive voltage supply controller 100 shown in FIG. 3.

Referring to FIG. 4, the adaptive voltage supply controller 100 includes a voltage level detection unit 110, a voltage supply control unit 120, a supply voltage generation unit 130, and a bypass circuit unit 140.

The voltage level detection unit 110 detects whether an applied voltage (V_{IO}) corresponds to a first voltage or a second voltage, both being supplied from an external source.

For example, if the applied voltage (VIO) is 1.8 [V], it is referred to as the first voltage; if the applied voltage is 1.2 [V], it is referred to as the second voltage.

The voltage level detection unit 110 transmits a detection signal according to the detection result to the voltage supply control unit 120.

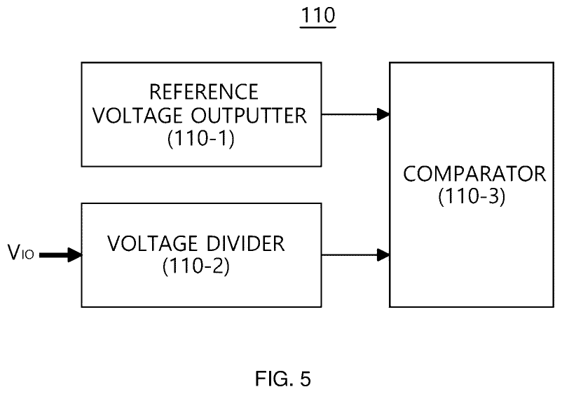

FIG. 5 shows an embodiment of the voltage level detection unit 110, which includes a reference voltage outputter 110-1, a voltage divider 110-2, and a comparator 110-3.

The reference voltage outputter 110-1 is a module that outputs a constant voltage (i.e., a reference voltage) regardless of the magnitude of the applied voltage (VIO) (for example, 1.8 [V] or 1.2 [V]). The output voltage of the reference voltage outputter 110-1 is input to the comparator 110-3.

The voltage divider 110-2 is a module configured such that its output voltage varies depending on the magnitude of the applied voltage (V_{IO}). The output voltage of the voltage divider 110-2 is also input to the comparator 110-3.

The comparator 110-3 may output a detection signal whose output value is distinguished according to the applied voltage (e.g., 1.2 [V] or 1.8 [V]) by comparing the output voltage of the reference voltage outputter 110-1 and the output voltage of the voltage divider 110-2.

The voltage supply control unit 120, based on the detection signal transmitted from the voltage level detection unit 110, controls the supply voltage generation unit 130 to operate when the first voltage is detected, and controls the second voltage to be provided as a supply voltage for operating the switch 500 via the bypass circuit unit 140 when the second voltage is detected.

That is, upon receiving a detection signal from the voltage level detection unit 110 indicating that the applied voltage (VIO) is 1.8 [V], the voltage supply control unit 120 transmits a control signal to the supply voltage generation unit 130 to cause it to generate a supply voltage.

In addition, upon receiving a detection signal from the voltage level detection unit 110 indicating that the applied voltage (VIO) is 1.2 [V], the voltage supply control unit 120 connects the bypass circuit unit 140 to the bias voltage generation unit 300 so that 1.2 [V], corresponding to the second voltage, can be provided as the supply voltage via the bypass circuit unit 140.

In addition, upon receiving a detection signal from the voltage level detection unit 110 indicating that the second voltage (for example, 1.2 [V]) is applied, the voltage supply control unit 120 stops the operation of the supply voltage generation unit 130 in order to prevent it from generating a supply voltage.

The supply voltage generation unit 130 generates a supply voltage for operating the switch 500 from the first voltage under the control of the voltage supply control unit 120.

For example, upon receiving a control signal for generating a supply voltage from the voltage supply control unit 120, the supply voltage generation unit 130 may generate a supply voltage of 1.2 [V] from an applied voltage of 1.8 [V].

The generated supply voltage is raised or lowered to a specific voltage via the bias voltage generation unit 300. That is, when a voltage of 1.2 [V] is supplied from the supply voltage generation unit 130, the negative voltage generator 310 of the bias voltage generation unit 300 generates and outputs −2.4 [V], which corresponds to twice the negative voltage from 1.2 [V], and the positive voltage generator 320 generates and outputs 2.4 [V], which corresponds to twice the positive voltage from 1.2 [V].

In addition, the supply voltage generation unit 130 may be programmed to output a variable supply voltage for the operation of the switch 500, and may output a programmed variable voltage under the control of the voltage supply control unit 120.

For example, upon receiving a control signal for generating a supply voltage from the voltage supply control unit 120, the supply voltage generation unit 130 may generate and output a programmed variable voltage (ranging from 1.2 [V] to 1.8 [V]) in correspondence with an applied voltage of 1.8 [V], or generate and output a programmed variable voltage (ranging from 0.9 [V] to 1.2 [V]) in correspondence with an applied voltage of 1.2 [V], according to the control signal from the voltage supply control unit 120.

The bypass circuit unit 140 corresponds to a circuit for bypassing the second voltage to the switch 500. The bypass circuit unit 140 includes a circuit configuration for connection with the bias voltage generation unit 300 under the control of the voltage supply control unit 120.

For example, if the applied voltage (V_{IO}) corresponds to 1.2 [V] and the circuit is switched to a circuit-connected state with the bias voltage generation unit 300 under the control of the voltage supply control unit 120, the bypass circuit unit 140 transmits 1.2 [V], which corresponds to the applied voltage (VIO), to the bias voltage generation unit 300 as the supply voltage for operating the switch 500.

In terms of the operation according to the components of the present invention described above, the voltage level detection unit 110 detects whether the externally applied voltage is, for example, 1.8 [V] or 1.2 [V].

If the applied voltage is 1.8 [V], then under the control of the voltage supply control unit 120, a certain voltage (for example, 1.2 [V]) is output through the supply voltage generation unit 130. Using this voltage, the bias voltage generation unit 300, namely, the negative voltage generator 310 and the positive voltage generator 320, generates the gate/body bias for the switch 500. That is, when 1.8 [V] is applied from an external source, the internal supply voltage generation unit 130 outputs 1.2 [V], and the negative voltage generator 310 generates-2.4 [V] and the positive voltage generator 320 generates +2.4 [V] to control the gate/body bias of the switch 500.

On the other hand, if the applied voltage is 1.2 [V], the supply voltage generation unit 130 is disabled, and the externally applied voltage of 1.2 [V] is delivered to the switch 500 via the bias voltage generation unit 300 through the bypass circuit unit 140. That is, when a power supply of 1.2 [V] is applied from an external source, 1.2 [V] signal is applied to the analog circuit through the bypass circuit unit 140, and the negative voltage generator 310 generates-2.4 [V], while the positive voltage generator 320 generates +2.4 [V], thereby controlling the gate/body bias of the switch 500.

In conclusion, when the externally applied voltage is 1.8 [V]/1.2 [V], a voltage of 1.2 [V] may be applied to the analog circuit by using the voltage level detection unit 110, the voltage supply control unit 120, the supply voltage generation unit 130, and the bypass circuit unit 140, the bias voltage generation unit 300 then generates −2.4 [V] and +2.4 [V], and through this, the gate/body bias of the switch 500 may be controlled. Therefore, the performance of the switch 500 above a certain standard may be ensured regardless of the level of the applied voltage supplied from an external source.

Although the technical idea of the present invention has been described with reference to the accompanying drawings, this is provided to illustrate only preferred embodiments of the present invention and does not limit the present invention.

Therefore, the present invention is not limited to the specific preferred embodiments described above, and it is obvious to those skilled in the art that many modifications may be made thereto without departing from the subject matter of the present disclosure set forth in the appended claims, and such modifications fall in the scope of the appended claims.

### REFERENCE NUMERALS

100: ADAPTIVE VOLTAGE SUPPLY CONTROLLER
110: VOLTAGE LEVEL DETECTION UNIT
120: VOLTAGE SUPPLY CONTROL UNIT
130: SUPPLY VOLTAGE GENERATION UNIT
140: BYPASS CIRCUIT

What is claimed is:

1. An adaptive voltage supply controller comprising:
a voltage level detection unit configured to detect whether an applied voltage corresponds to a first voltage or a second voltage, both being supplied from an external source;
a supply voltage generation unit configured to generate, from the first voltage, a supply voltage for operating a switch that performs a switching operation between a transmission mode and a reception mode for a high-frequency radio signal;
a bypass circuit unit configured to bypass the second voltage to the switch; and
a voltage supply control unit configured to, based on a detection result of the voltage level detection unit, control the supply voltage generation unit to operate when the first voltage is detected, and control the second voltage to be provided as a supply voltage for operation of the switch via the bypass circuit unit when the second voltage is detected.

2. The adaptive voltage supply controller of claim 1, wherein the voltage supply control unit is configured to stop an operation of the supply voltage generation unit when the voltage level detection unit detects that the second voltage is applied.

3. The adaptive voltage supply controller of claim 1, wherein the voltage supply control unit is programmed to output a supply voltage to be supplied to the switch in a variable manner under the control of the voltage supply control unit.
